(19) United States
(12) Patent Application Publication
(10) Pub. No.: US 2011/0215988 A1
(43) Pub. Date: Sep. 8, 2011

(54) DUAL-DISPLAY ELECTRONIC DEVICE

(75) Inventor: SONG-LING YANG, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/824,484

(22) Filed: Jun. 28, 2010

(30) Foreign Application Priority Data
Mar. 2, 2010 (CN) 201010116077.7

(51) Int. Cl. G09G 5/00

(52) U.S. Cl. 345/1.1

(57) ABSTRACT

A dual-display electronic device includes a housing, a support unit received in the housing, an LCD unit supported on a first surface of the support unit, an e-paper, a holder, electro-magnets, and an elastic unit. The holder is fixed on an end of the e-paper above the LCD unit and is slidably mounted on the first surface of the support unit. The electro-magnets are arranged along a direction the holder slides, to attract the holder when powered on. The e-paper wraps around an end of the support unit and extends to a second surface of the support unit. The elastic unit connects a free end of the e-paper to the support unit at the second surface.

### BACKGROUND

1. Technical Field

The present disclosure relates to electronic devices and, particularly, to an electronic device with dual display.

2. Description of Related Art

Electronic devices, such as electronic books, usually adopt electronic paper (e-paper) or liquid crystal displays (LCD) as there display panels. E-paper and LCD have there own advantages. E-paper is power saving and mimics printed paper well. The LCD can show more colors and have a quick refresh rate. Some electronic devices adopt both E-paper and an LCD, but electronic devices with two display units are too big.

Thus, what is needed is an electronic device utilizing both the e-paper and the LCD and having a small size.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic, isometric view of a dual-display electronic device in a closed state according to one embodiment.

FIG. 2 is an exploded view of FIG. 1.

FIG. 3 is an enlarged view of circled portion III of FIG. 2.

FIG. 4 is an enlarged view of circled portion IV of FIG. 2.

FIG. 5 is a schematic, isometric view of the dual-display electronic device of FIG. 1 with an upper housing of the electronic device removed.

FIG. 6 is a cross-sectional view of the dual-display electronic device of FIG. 1.

FIG. 7 is an enlarged view of circled portion VII of FIG. 6.

FIG. 8 is a schematic, isometric view of the dual-display electronic device of FIG. 1 with a bottom housing of the electronic device removed.

### DETAILED DESCRIPTION

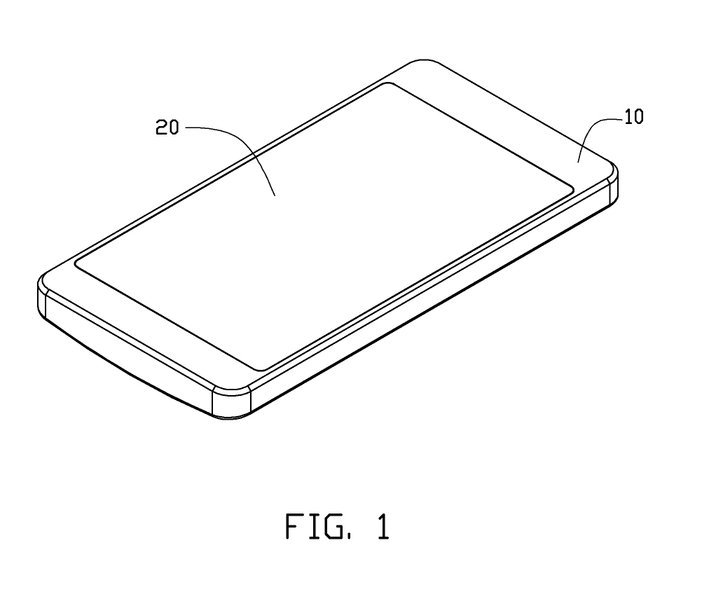

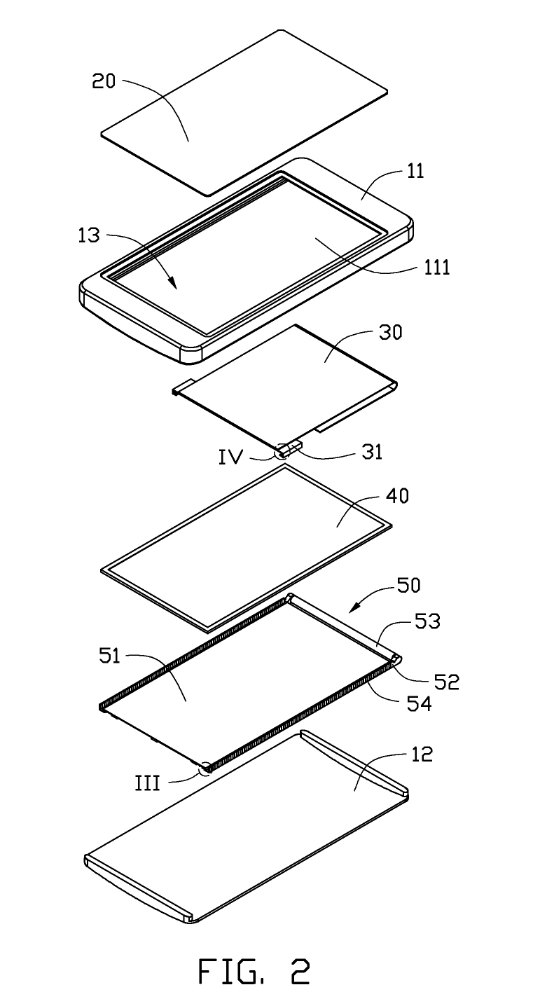

Referring to FIGS. 1 and 2, a dual-display electronic device according to one embodiment is illustrated. The electronic device includes a housing 10, a touch unit 20 mounted on the housing 10, an e-paper 30 and an LCD unit 40 received in the housing 10, and a support unit 50 supporting the e-paper 30 and the LCD unit 40.

The housing 10 can be rectangular. The housing 10 includes an upper housing 11 and a bottom housing 12. The upper housing 11 defines a stepped opening 111. The touch unit 20 is mounted in the stepped opening 111. The upper housing 11 and the bottom housing 12 cooperatively form a receiving space 13 for receiving the support unit 50, the LCD unit 40, and the e-paper 30. The receiving space 13 communicates with the opening 111 so that a user can view the e-paper 30 and the LCD unit 40 through the opening 111.

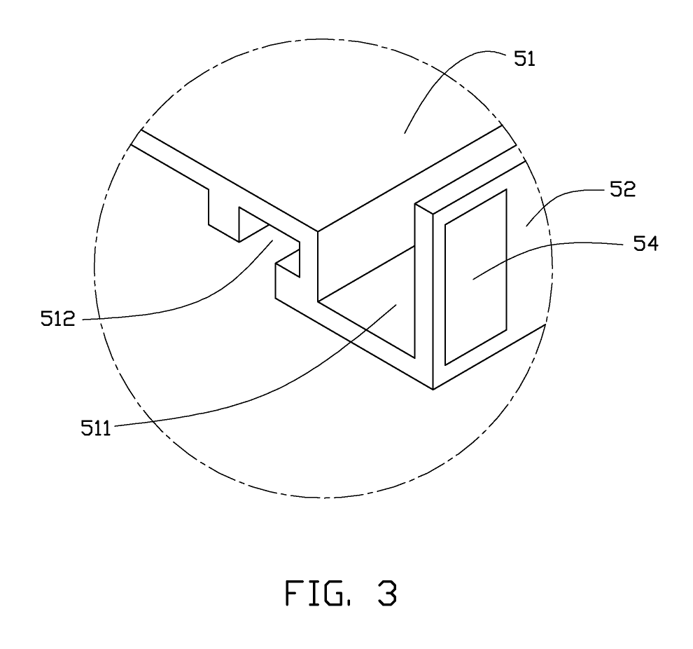

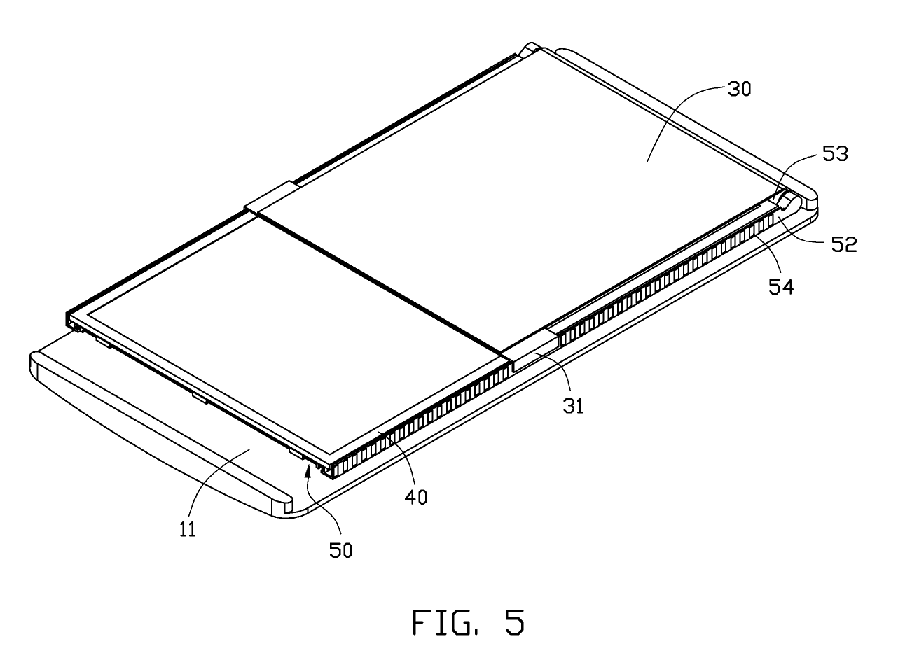

The support unit 50 includes a support board 51, two rails 52 located at opposite sides of the support board 51, and a roll shaft 53 located between the two rails 52. The roll shaft 53 is rotatably mounted on an end of the support board 51. The support board 51 can be rectangular. Referring also to FIG. 3, the support board 51 defines grooves 511 on a front surface facing the opening 111. The grooves 511 are adjacent to the rails 52. A plurality of electro-magnets 54 can be mounted on the rails 52 and spaced from each other. Referring to FIG. 5, the LCD unit 40 is carried on the front surface of the support board 51.

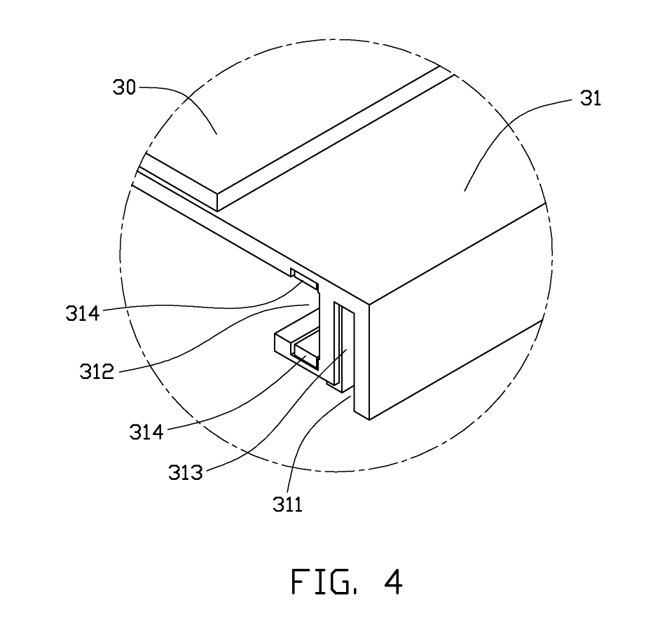

Referring to FIGS. 2 and 4, a holder 31 is mounted on an end of the e-paper 30. The holder 31 can be rectangular. Two sides of the holder 31 extend towards the support unit 50. Rail grooves 311 are defined in the extending portions of the holder 31 and face the rails 52. Receiving grooves 312 are defined in the inner surface of the extending portions and face each other. First magnets 313 are mounted on the holder 31 in the rail grooves 311, so that the holder 31 can be attracted by the electro-magnets 54. In other embodiments, the holder 31 is made up of magnetic material, so that the holder 31 can be attracted by the electro-magnets 54.

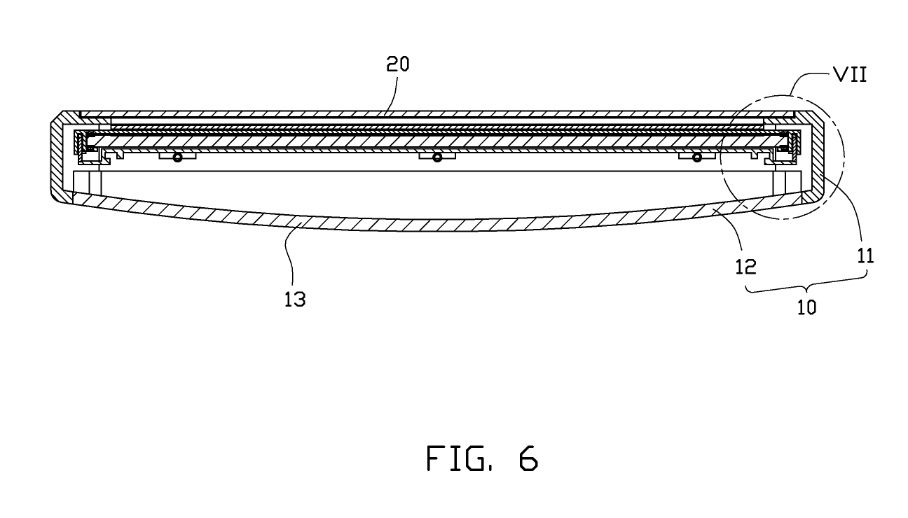

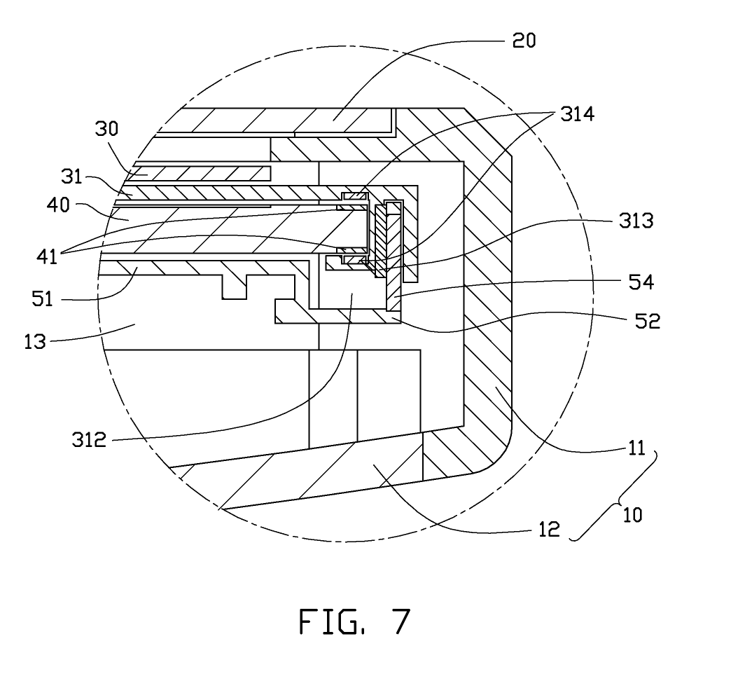

Referring to FIGS. 5, 6, and 7, the rails 52 are fitted over the rail grooves 311, thus the holder 31 is slidable along the rails 52. Two sides of the LCD unit 40 are inserted into the receiving grooves 312. Second magnets 314 are mounted on the holder 31 in the receiving grooves 312. Third magnets 41 are mounted on the LCD unit 40 facing the second magnets 314. The second magnets 314 and the third magnets 41 are oriented to repulse each other, thus providing a magnetic force to suspend the holder 31 above the rails 52, so that the holder 31 can slide smoothly above the rails 52.

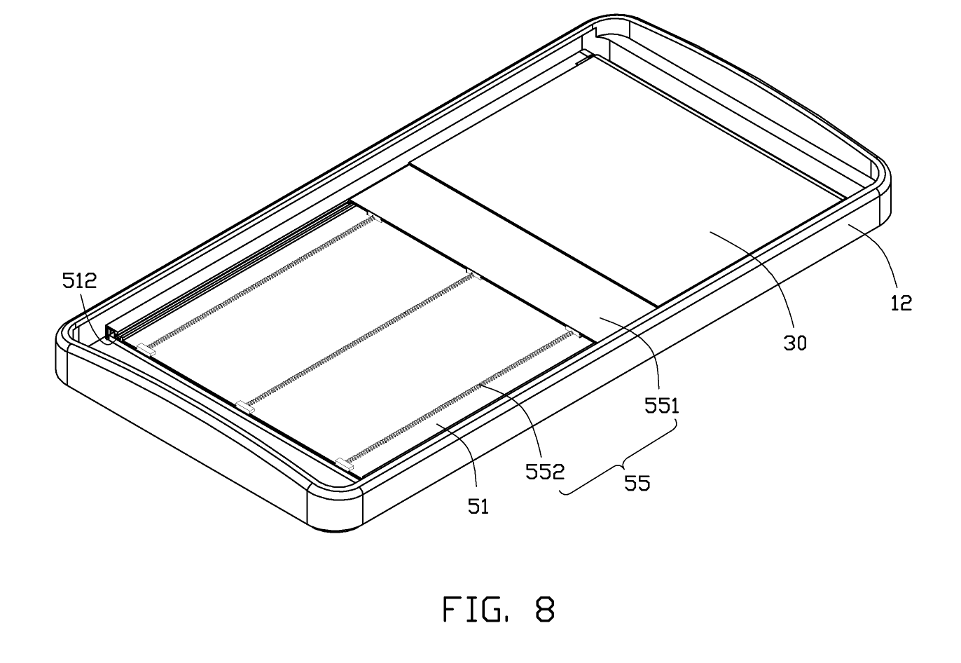

Referring to FIGS. 5 and 8, an elastic unit 55 is slidably mounted on a back surface of the support board 51 away from the opening 111. In this embodiment, the support board 51 defines slide grooves 512 on opposite sides of the back surface thereof (referring to FIG. 3). The slide grooves 512 are adjacent to and substantially parallel to grooves 511. The elastic unit 55 includes a slider 551 and a plurality of elastic pieces 552. The slider 551 is slidably mounted in the slide grooves 512. The elastic pieces 552 connect the slider 551 to the end of the support board 51. One end of the e-paper 30 is fitted around the roll shaft 53 and connected with the slider 551.

When the electro-magnets 54 on the rails 52 are powered off, the elastic pieces 552 can drive the slider 551 to move apart from the roll shaft 53, and the slider 551 can pull the e-paper 30 to move to the back surface of the support board 51. As a result, the LCD unit 40 on the front surface of the support board 51 is exposed. When one of the electro-magnets 54 is powered on, the electro-magnet 54 can attract the magnet 313 mounted on the holder 31, and hold the e-paper 30 with the holder 31 at the position of the electro-magnet 54. When different electro-magnets 54 are powered on, the e-paper 30 can be fully positioned at the front surface of the support board 51 and fully cover the LCD unit 40, or partly positioned at the front surface of the support board 51, with a part of the LCD unit 40 exposed.

A user can operate the touch unit 20 to control the e-paper 30 to stay at different positions. That is, the user can use a sliding touch on the touch unit 20 with their finger, to input instructions such as controlling which of the electro-magnets 54 to power on, so that the e-paper 30 can be positioned at a desired position.

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A dual-display electronic device comprising:
a housing;
a support unit received in the housing;
an LCD unit supported on a first surface of the support unit;
an e-paper;
a holder fixed on an end of the e-paper, slidably mounted on the first surface of the support unit, and positioned above the LCD unit;
electro-magnets arranged along a direction the holder slides, to attract the holder when powered on; and
an elastic unit, wherein the e-paper wraps around an end of the support unit and extends to a second surface of the support unit, and the elastic unit connects a free end of the e-paper to the second surface of the support unit.

2. The dual-display electronic device of claim 1, wherein the electro-magnets are spaced apart from each other.

3. The dual-display electronic device of claim 1, further comprising a touch unit mounted on the housing above the e-paper, wherein the touch unit receives a user's manipulation to power on or power off the electro-magnets.

4. The dual-display electronic device of claim 1, wherein the support unit comprises a support board and a roll shaft rotatably mounted on the end of the support board.

5. The dual-display electronic device of claim 1, wherein the elastic unit comprises a slider slidably mounted on the second surface of the support unit and elastic pieces connecting the slider to the support unit.

6. The dual-display electronic device of claim 4, wherein the support unit further comprises rails mounted on the support board, the holder slidably fitting over the rails.

7. The dual-display electronic device of claim 6, further comprising magnets mounted on the holder and the LCD unit, wherein the magnets are repulsive to each other to provide a magnetic force to suspend the holder above the rails.

8. The dual-display electronic device of claim 1, further comprising a magnet mounted on the holder so that the holder is attractable by the electro-magnets.

9. A dual-display electronic device comprising:
a housing defining an opening and a receiving space communicating with the opening;
a support unit received in the receiving space;
an LCD unit supported on a first surface of the support unit facing the opening;
an e-paper;
a holder fixed on an end of the e-paper, slidably mounted on the first surface of the support unit, and positioned above the LCD unit;
electro-magnets arranged along a direction the holder slides, to attract the holder when powered on; and
an elastic unit, wherein the e-paper extends around an end of the support unit and extends to a second surface of the support unit far away from the opening, and the elastic unit connects a free end of the e-paper to the second surface of the support unit.

10. The dual-display electronic device of claim 9, wherein the electro-magnets are spaced apart from each other.

11. The dual-display electronic device of claim 9, further comprising a touch unit mounted on the housing above the e-paper, wherein the touch unit receives a user's manipulation to power on or power off the electro-magnets.

12. The dual-display electronic device of claim 9, wherein the support unit comprises a support board and a roll shaft rotatably mounted on the end of the support board.

13. The dual-display electronic device of claim 9, wherein the elastic unit comprises a slider slidably mounted on the second surface of the support unit and elastic pieces connecting the slider to the support unit.

14. The dual-display electronic device of claim 12, wherein the support unit further comprises rails mounted on the support board, the holder slidably fitting over the rails.

15. The dual-display electronic device of claim 14, further comprising magnets mounted on the holder and the LCD unit, wherein the magnets are repulsive to each other to provide a magnetic force to suspend the holder above the rails.

16. The dual-display electronic device of claim 9, further comprising a magnet mounted on the holder so that the holder is attractable by the electro-magnets.
